(19) United States
(12) Patent Application Publication
(10) Pub. No.: US 2013/0177379 A1
(43) Pub. Date: Jul. 11, 2013

(54) AUTOMATED LAYER PICKING AND STORAGE SYSTEM

(71) Applicant: KUKA Systems Corporation North America, Sterling Heights, MI (US)

(72) Inventors: ROBERT A. HOFFMAN, Marysville, MI (US); Christian Wurll, Newnan, GA (US)

(21) Appl. No.: 13/734,267

(22) Filed: Jan. 4, 2013

Related U.S. Application Data
(60) Provisional application No. 61/631,537, filed on Jan. 6, 2012.

(51) Int. Cl. B65G 57/00

(52) U.S. Cl. CPC B65G 57/00
USPC 414/791.6; 414/799; 414/802; 414/800

(57) ABSTRACT

A material handling storage, retrieval and load building system receives source pallets, bearing product loads in full or partial layers, stores them in a variety of locations depending on the frequency of demand for products thereon and builds homogeneous product or similar product full or partial layers on target or order pallets, in both single and multiple layer picks, from products on the source pallets, to order after retrieving the source pallets to a building pallet location. Pallets are transferred within the system on pallet stands which are selectively coupled to automatically guided vehicles, thus providing significant flexibility in the pallet storage locations and in the transfer distance within the system. Apparatus and methods are disclosed.

### RELATED APPLICATION

This application claims priority to U.S. Ser. No. 61/631,537 filed Jan. 6, 2012, the disclosure of which is hereby incorporated herein by reference in its entirety.

### FIELD OF THE INVENTION

This invention relates to material handling and more particularly to a system for receiving diverse products, storing products, creating an assembly of the same or dissimilar products and discharging the assembly. Moreover, the invention relates to the optimization of the movement, assembly and discharge of products, and apparatus and methods therefor.

### BACKGROUND OF THE INVENTION

It is known to provide a facility which receives products in quantity, typically on first pallets bearing homogeneous or similar products, which locates those first pallets at determined positions, which selects those first pallets bearing designated products, which builds a target pallet having a mix of products from one or more first pallets and which then discharges the target pallet to fill an order.

Such a facility is typically large enough to handle hundreds or thousands of pallets which may range, with product thereon, from 1500 pounds and up to 6000 pounds or so, each.

The weight and size of such pallet-carried loads presents functional and hazardous obstacles to the efficient handling of the incoming, stored and “picked” or assembled product loads. For example, the overall distance between an infeed location, a stored location, a target forming location and a discharge location may be long, increasing the time for travel therebetween, and typically requiring coordinated function among many pallet and product handling devices. The number of these locations and these devices, the coordination and clearances required between them, the moving components or devices and the spacing between the locations are all weak links to the goal of increasing product throughput.

Attempts at positioning these respective locations in the closest positions for optimal throughput, given the variety of products handled, are still hampered, for example, by the size and weight of the pallets used, by the nature of the equipment necessary for pallet and load handling, and by the need to coordinate non-interfering component movement.

Accordingly, it has been one objective of this invention to provide apparatus and methods for enhancing the throughput capacity of a product receiving, storing, picking and discharge operation in a material handling system.

Another objective of the invention has been to provide apparatus and methods for more efficient handling of products through such a system.

Another objective of the invention has been to provide a product receiving, storing, picking, load building and discharge system wherein priority of spacing of these functional stations is a function of the most frequently handled products.

A further objective of the invention has been to provide a material handling system for more efficient handling and movement of large numbers of heavy product loads, and to provide flexibility in the use of load carrying pallets through the system.

A further objective of the invention has been to provide an improved material handling, storing, assembling and discharge system with capacity for expansion as product volume grows.

A further objective of the invention has been to provide improved pallet handling and transport.

### SUMMARY OF THE INVENTION

To these ends, the invention in one embodiment comprises a material handling system having a plurality of stations such as a source pallet input station; source pallet storage stations; a pallet load building station where a product load is built on a target pallet, and a target pallet discharge station, and where pallets are transported between stations of the plurality of stations, in part, on mobile pallet stands driven by automatic guided vehicles which selectively couple to the stands and deliver them and a pallet thereon to a programmed destination. Alternately, pallets are carried directly in an automatic guided vehicle, and some pallets are conveyed to storage by conventional means. Preferably, according to the invention, products are assembled on a target pallet in homogeneous or similar full or partial product layers before discharge of the target pallet to fill an order.

In another aspect of the invention, the spatial relationship of the source pallet storage areas to a load building station, where products are picked from a source pallet and placed on a target pallet, is a function of product priority, that is to say that source pallets containing products most frequently called for in building a target pallet load are located in a storage location closer to the load building station than source pallets bearing products of less frequent use, all to lessen the distance required for travel of source pallets of more frequent demand and thus enhance overall throughput.

In another aspect of the invention, products from source pallets moved to a load building station are placed onto a target pallet by any suitable device, such as a high speed layer picking system, implemented by an area gantry robot operating over an area accommodating a plurality of parked mobile pallet stands. Each of these positions may comprise or become a source pallet or target pallet location, thus providing extensive flexibility in load building and throughput. For example, an emptied source pallet may become a new target pallet without initial removal of the empty source pallet to an empty pallet storage bank. Moreover, negative load building can be accomplished by removing one or more product layers from a source pallet then using the partially depleted source pallet as a new (starter) target pallet.

These and other objectives and advantages will become readily apparent from the following written description and from the drawings in which:

### BRIEF DESCRIPTION OF THE DRAWINGS

FIG. 1 is an overall diagrammatic illustration showing an overall material handling system according to an embodiment of the invention;

FIG. 2 is a view similar to FIG. 1 but in addition including an overlay showing generally the flow of pallets in the system, together with examples of various pallet, product case and AGV flow;

FIG. 3 is a view similar to FIG. 1 but showing only the so-called fixed portions or locations of the system, the other portions not in FIG. 3 but in FIG. 1 being programmable and moveable;

FIG. 4 is a diagrammatic illustration comprising an analogous computer architecture, for illustrative purposes only, to help clarify the invention;

FIG. 5 is an isometric view of an automatic guided vehicle according to the invention;

FIG. 6 is an isometric view of an automatic guided vehicle of FIG. 5 illustrating several features thereof, and of a mobile pallet stand moveable by the automatic guided vehicle;

FIG. 7 is a diagrammatic view of one form of high speed layer picking system according to the invention;

FIG. 8 is an illustrative layout of one form of an expanded system of the invention with an expanded automated storage and retrieval system; and

FIG. 9 is a block diagram illustrating the operable interfaces of an AGV with operations of the system of the invention.

### DETAILED DESCRIPTION OF THE INVENTION

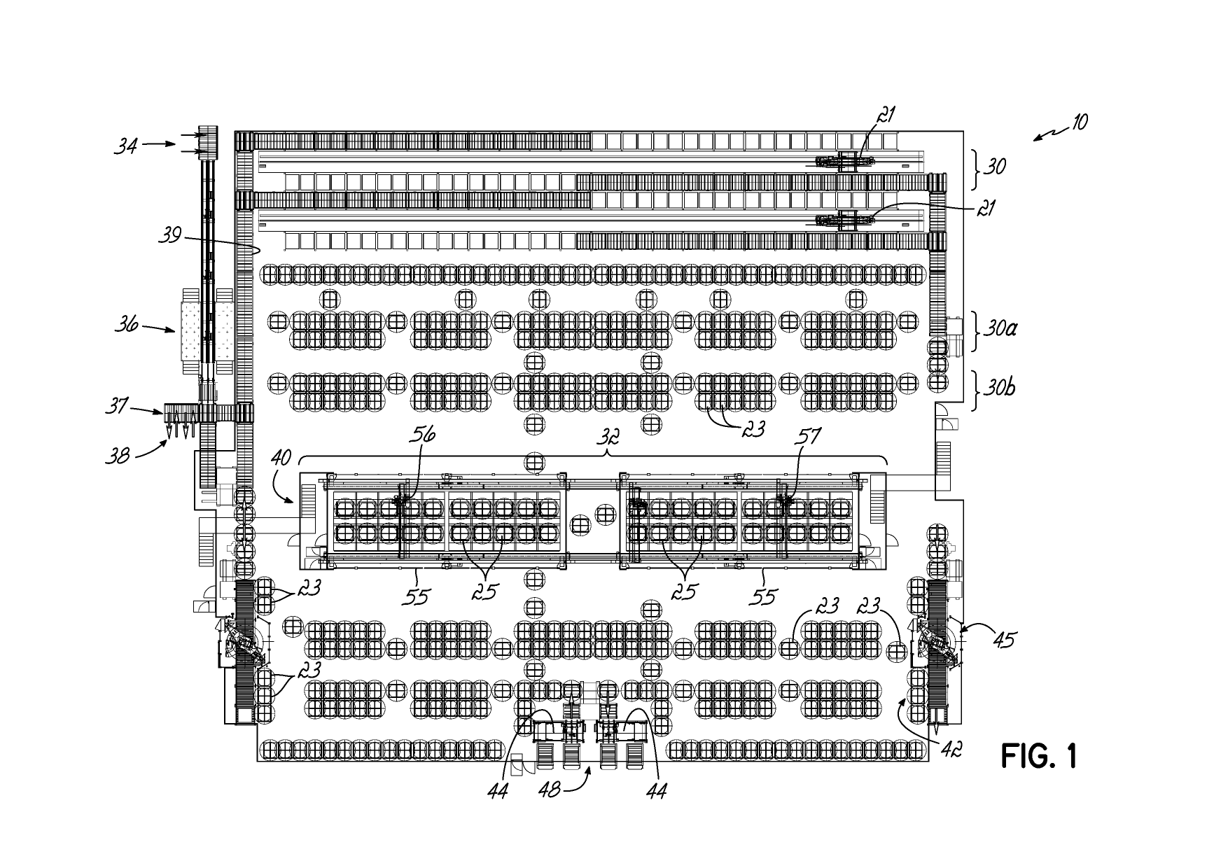

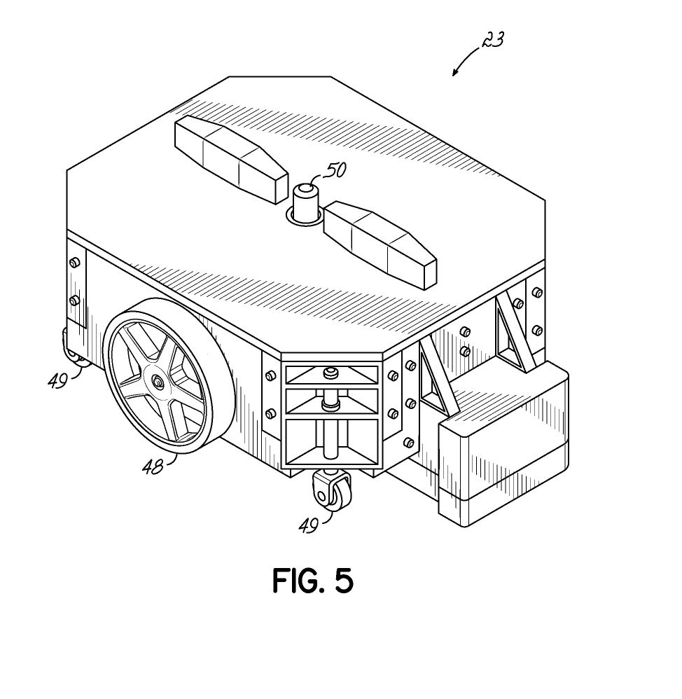

Turning now to the FIGS., the following is a more detailed description of the invention. FIGS. 1, 2, 3, 4 and 8 illustrate components of the overall system while FIGS. 5-7 illustrate details of components in the system.

This invention includes a system configured to present multiple homogeneous pallets of product (Source Pallets) and multiple assembly pallets (Target Pallets) for automated assembly of homogeneous or similar full or partial product layers on Order Pallets (Rainbow Pallets) for discharge to fill orders of mixed (or the same) products in pallet-sized loads. This system includes or provides in combination some or all of the following devices and functions:

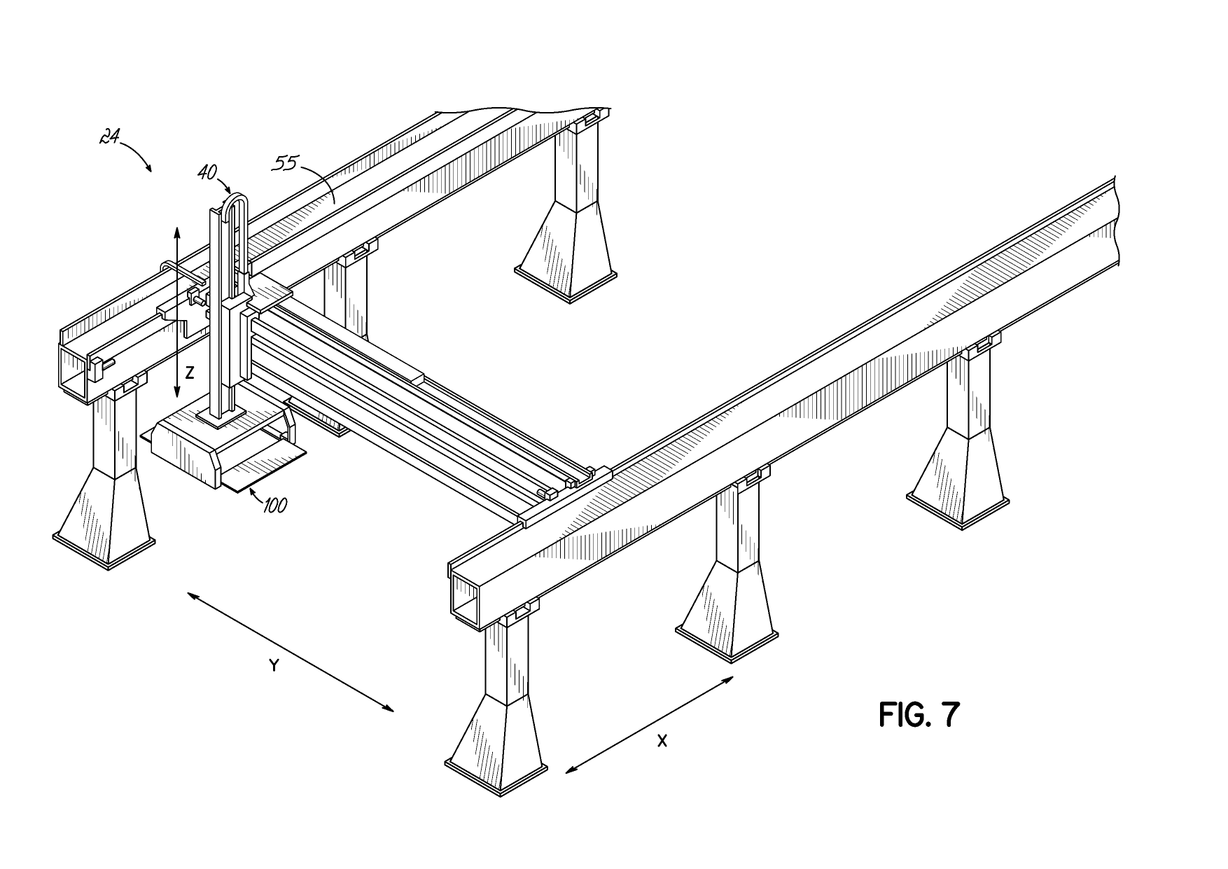

Robotic Manipulating Devices including but not limited to load assembling or building apparatus, articulating robots, linear gantry units, area gantry units such as in FIG. 7 and cantilevered linear devices.

Layer Gripper Units (see FIG. 7), of any suitable form, that are mounted to the robotic manipulating devices that will be powered by pneumatics, vacuum, electro-mechanical, hydraulic or any combination of these. These units can pick either single or multiple homogeneous or similar full or partial product layers per individual pick. In some applications the layer grippers may also drop a single or portion of the multiple full or partial layers to multiple target pallets.

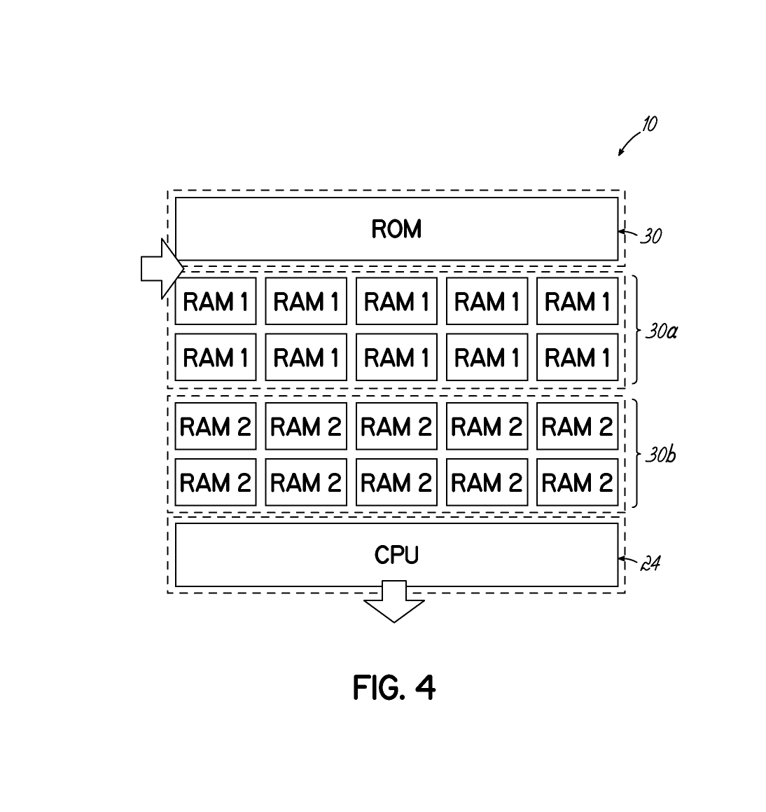

Automatic Guided Vehicles (AGV's) or Load Transporting Vehicles, see FIG. 5, will supply or transport the Source and Target Pallets either within a matrix pattern positioned inside the robotic manipulating devices work envelope or in some cases the Source and Target pallets may be pre-staged outside the robotic manipulating devices envelope for fast pickup and delivery of pallets to an operational location. These pre-stage areas are described as “ROM” and “RAM” Storage within this document, analogous to the illustration of a computer chart as in FIG. 4.

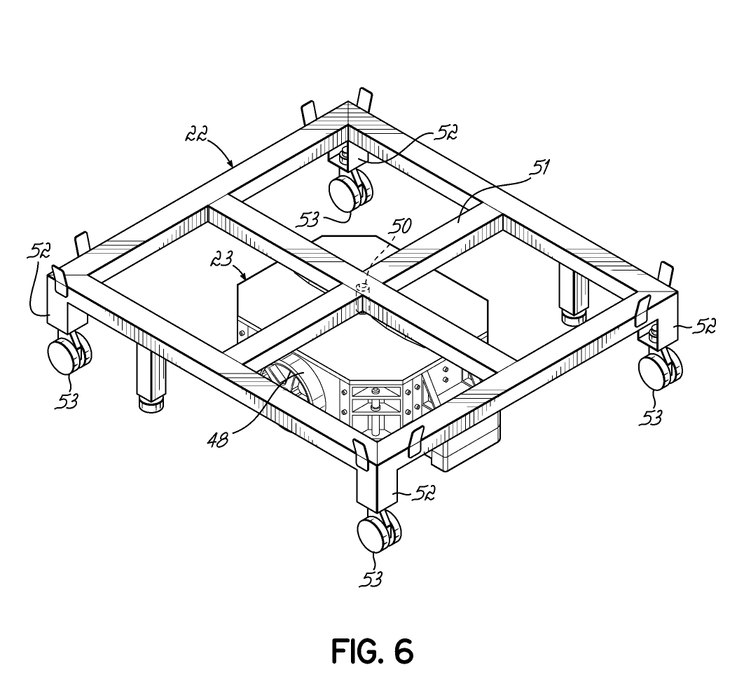

AGV Ancillary Devices (see FIG. 6) are used to assist the AGV's in carrying the pallets. These devices include but are not limited to portable roller carriers, pallet supporting mobile platforms, portable stand carriers (requires lift on the AGV), pallet stands, AGV mounted roller conveyors, AGV mounted belt conveyors or a modified AGV that uses a lift to deliver the pallet to a static load stand permanently mounted to the floor.

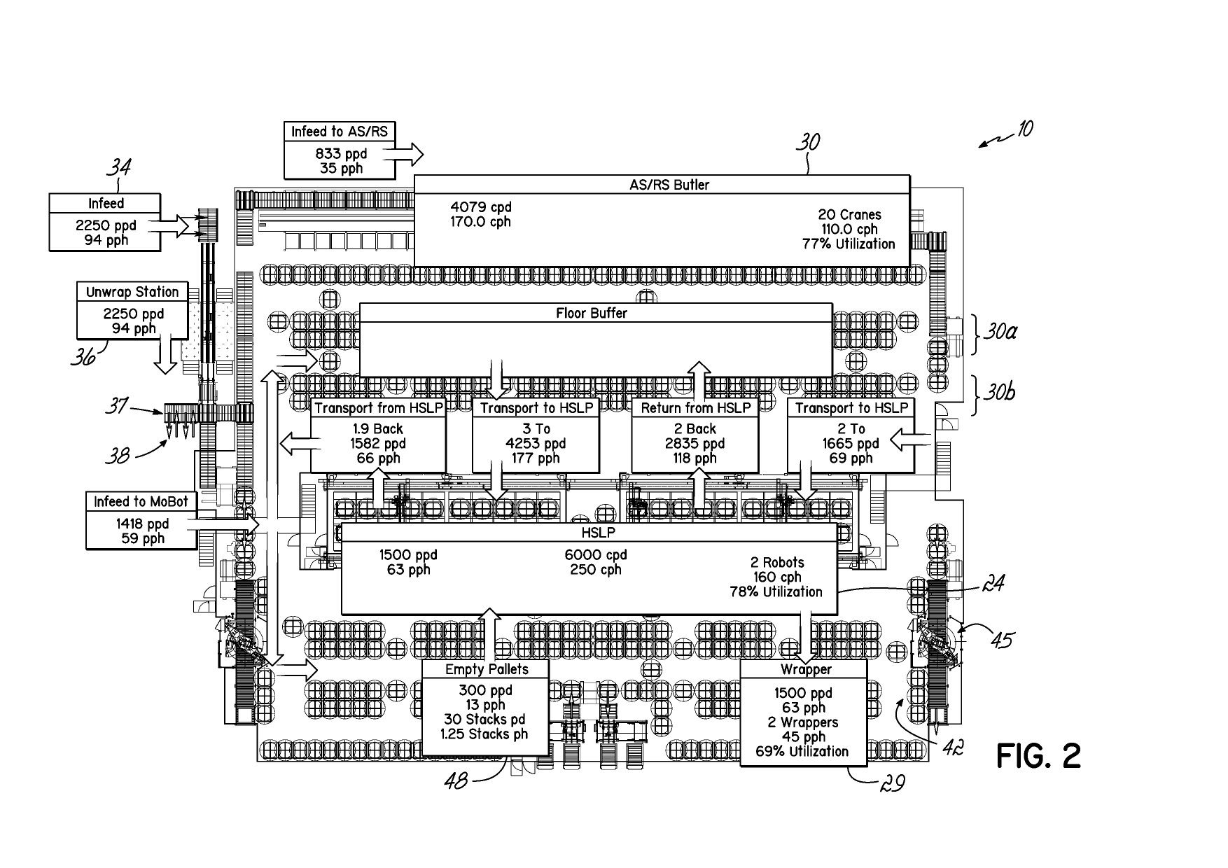

Load Storing and Retrieval Apparatus (see FIGS. 1 and 2) comprising any suitable cranes, conveyors and fixed storage racks are used to store incoming or source pallets, for example, in accessible storage locations, the exact structure thereof not comprising a part of the invention.

Load Assembling or Building Apparatus (see FIG. 7) comprising product grippers of any suitable type are effective to transfer items to a target pallet and Robot Manipulating Devices.

In addition to the foregoing the goals and objectives of the invention include, in no particular order:
Automatic Full or Partial Layer Picking
Optimizing Material Flow
Increasing Safety of Material Goods Handling in Warehouse
Reducing Potential for Product Damage
Elimination of Layer Picking Labor
Providing Flexibility and Expandability or Future Operations
Less Dependency on Manual Labor for Picking to Pallets
Providing a Redundant and Modular System that Handles Preventative Maintenance Shutdowns with Minimal Interruptions to Production
Capacity to handle both full and partial layers

Benefits of the invention include:
System Flexibility: Easy to introduce new SKUs without impacting functionality.
Growth Potential and Expandability: Easy to expand as volume grows.
System Redundancy: Allows for minimal disruption during unexpected downtimes.
System Modularity: Easy to swap most components in and out and allows for minimal disruption to the system during planned preventative maintenance.
System Footprint: The proposed system is relatively compact in footprint considering the amount of automation that is incorporated along with all of the other benefits referenced above.
Scalability: facilitates of modification to size and capacity requirements.
Dynamic Storage and Load Building: Facilitates economic and minimal product and pallet motion from source pallet input to target pallet discharge.

These and other advantages of the invention described herein will be readily apparent to those of ordinary skill in the art to which this invention relates.

### The Basic System/Analogy to Computer Architecture:

The invention comprises a material handling system which has an analogy, for descriptive purposes, to a computer architecture, such as illustrated in FIG. 4. The invention provides a modular and scalable solution to material handling and it is comparable with a simplified memory architecture of computer as shown in FIG. 4. Following the computer analogy, a High Speed Layer Pick System (HSLP) of the invention is the Central Processing Unit (CPU) analogous to FIG. 4, and the source pallets are “bytes” which are stored in three different cache buffers 30, 30a and 30b FIGS. 1 and 4). Each buffer provides different accessing speeds depending on its Level value (Level 1 (30b) being the fastest and Level 3 (30) being the slowest). Thus pallets which are required less frequently are stored in the Level 3 buffer (30) and pallets which are required every loading block are stored in the Level 1 (30b) buffer.

A source pallet storage location (type of buffer in which it resides) can be adapted dynamically depending on its future usage. The pallet transportation between the buffers and to and from the HSLP is implemented by a swarm or plurality of mobile robots, referred to herein as automatic guided vehicles (AGVs).

System expansion can be implemented by increasing the appropriate cache buffer volume, by adding more AGVs or by adding more “CPU” power (HSLP capacity).

In FIG. 4, the numbers applied are from the other FIGS. 1 and 2, for example, indicating the analogy relationship.

Moreover, it will be appreciated that the invention herein resides in the system and processes described herein. While a variety of mechanisms, handlers, controls, grippers and other structural components are used to accomplish he movements and motions described herein, any suitable forms of hardware and software for accomplishing these functions, and which are readily appreciated from the disclosures herein, can be used as such, these specific components other than the systems and features particularly described herein comprise no part of the invention herein claimed.

### General System Detail:

Throughout this application and in the drawings, reference is made to a variety of abbreviations such as the following for purpose of description and flow parameters of pallets, cases, pallet stacks and the like:
HLSP High Speed Layer Picking
AGV Automated Guided Vehicle
BOT Short for Robot as in the AGV
ROM Read Only Memory
RAM Random Access Memory
CPU Central Processing Unit
PPD Pallets per Day
PPH Pallets per Hour
CPD Cases per Day
CPH Cases per Hour
PD Per Day
PH Per Hour

Moreover and throughout the drawings, the pallets and their respective positions are graphically illustrated by the squares (such as at 30 in FIGS. 1 and 2), while the positions of pallets on the stands 22 and AGVs 23 are illustrated by the encircled squares as in FIGS. 1 and 2, for example.

A layout of the invention in one embodiment is shown in FIGS. 1 with function or operational flows overlaid as in FIG. 2. There is shown in these FIGS. an automatic pallet receiving, storage, picking, assembling and discharge system 10 including
1 Pallet Unwrap Station and pallet in-feed into the cell, or buffer 30;
2 AS/RS Cranes 21 holding in total 760 single stacked pallets;
336 mobile pallet stands, 22;
35 AGVs, at various selectable positions 23;
2 High Speed Layer Picking Systems (HSLP) 24 with 40 pallet positions 25 in total in one embodiment shown;
1 Out-feed Lane connected to Pre-Print & Apply;
1 Label Printer;
1 Pallet Stacker;
2 Stretch Wrappers 29; and
Empty Packet Infeed or Outfeed Station 48.

As noted above, these components may be of any suitable construction and components. The AGVs 23 and the HSLP systems 24, along with the mobile pallet stands 22 comprise the major pallet movement and building components of the system, these other components being shown for environment and clarity of the overall system 10.

Moreover, the number of the components is variable as desired.

It will be appreciated that the AS/RS cranes 21 are located to stack source pallets in the storage area 30 (FIG. 1) while the two HSLP systems 24 are operatively associated with the assembly area 32 (FIG, 1).

In FIG. 1, there is an infeed station 34 at which source pallets are received and transferred to unwrap and checking stations at 36 and 37. Rejected pallets are transported to rejection lanes 38 for further handling.

Source pallets enter the system through the unwrap station 36. A contour check at station 37 verifies whether the inserted pallet meets the allowed dimensions. A barcode reader (not shown) confirms the expected pallet and registers the pallet in a Warehouse Control System of any suitable type operably connected to the material handling system 10. If the contour check was successful and the pallet is expected, an operator is requested to visually inspect the pallet and, if it is in “good shape” or otherwise acceptable to him, he removes the shrink wrap. Otherwise the pallet is routed to the reject lane 38. In case of a positive evaluation, the source pallets can either divert from buffer lane 39 into one of the two AS/RS aisles at 30 or are queued into buffer lane 39 ready to be picked up by mobile AGVs 23 for transportation to other programmed storage areas 30a, 30b noted in FIG. 1 and for analogy purposes in FIG. 7.

Area 30b is a primary or level 1 cache or buffer in which the most frequently demanded source pallets are held. Area 30a is a secondary or level 2 cache or buffer in which somewhat less frequently demanded source pallets are held. Area 30, the AS/RS, is a third level where the least frequently required pallets are held.

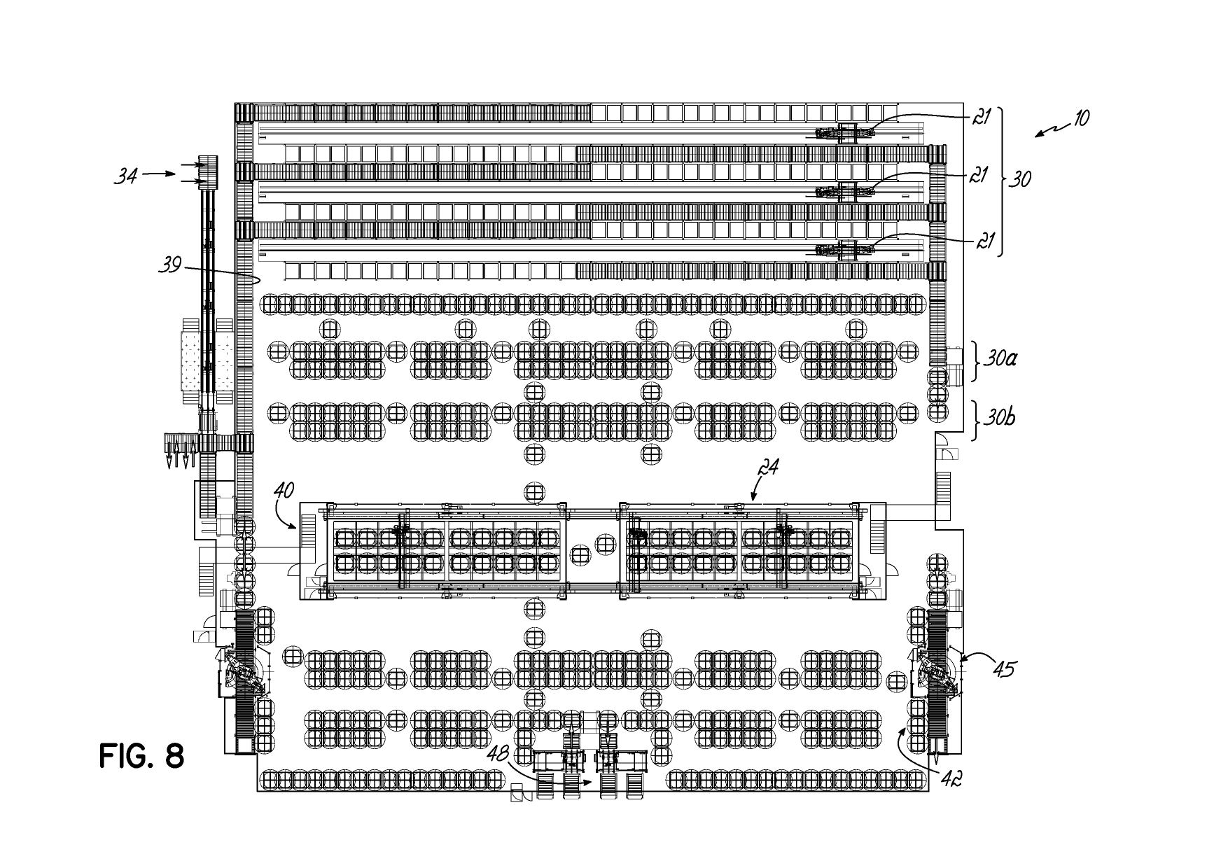

It will be appreciated that the AR/RS area 30 comprises, in one embodiment, two rows of source pallet storage racks for receiving source pallets from lane 39 handled by a crane 21 between the rows. Additional rack rows in an area 30 can be provided and serviced by cranes 21, or additional similar cranes (see FIG. 8, for example).

The AGVs 23 are cost efficient mobile carts or robots 23 (FIG. 5) which are able to carry a mobile pallet stand 22 (FIG. 6). The AGVs 23 move along inductive wires (such as floor embedded wires) which provide power as well as the navigation signals. Source pallets are transferred onto and off the mobile stand at handover stations which are implemented by standard pallet fork type devices. The AGVs 23 (FIG. 5) supply empty pallets, retrieve and return source pallets and pick up target pallets to and from the High Speed Layer Picking System (HSLP) 24. It will be appreciated that an AGV 23 can carry a pallet, directly thereon, but preferably can be selectively connected or coupled to a pallet stand 22 on which the pallet is supported for moving stand 22 as desired between stations. FIG. 6 illustrates an AGV 23 operably coupled via pin 50 (FIG. 5) to a stand 23.

The HSLP at 24 is implemented by an area gantry system 40 robot which is equipped with two bridges (only one shown illustratively in FIG. 7). Each bridge is equipped with a Layer Gripper 100 of any suitable form for gripping whole or partial product layers or individual products and lifting or transporting them to a directed location on another pallet. These layer grippers can be different designs depending on requirements. Using two different gripper types of grippers can enable the system to offer the highest package type flexibility. Layer grippers 100 (not shown) comprise end effectors for the system gantry 40 and are of vacuum or mechanical grips or claims, the details of which are not pertinent to this invention.

Underneath the area gantry system, 40 mobile pallet stands 22 can be parked within the working envelope of the system 40. Every pallet position can become a source or a target location. This enables reuse of an empty source pallet as a new target pallet without handling this empty pallet. This concept also allows negative picking (taking e.g. one layer off a source pallet and continuing to use the original pallet as a new (starter) target pallet).

The Warehouse Control System (of any suitable type) manages the complete pallet flow and assigns the order of pallet building to the appropriate HSLP system. A smart look ahead function optimizes the order pallet selection inside the active wave in order to minimize the pallet movement to and from the HSLP system 24. A Fleet Management component will ensure an efficient AGV 23 utilization with minimal AGV traffic jams and fast mission executions. Once an order pallet is completed, an AGV 23 will transfer the completed pallet to an outfeed lane 42 (FIG. 1) or will temporary park it an open storage location near the discharge to satisfy sequencing rules (e.g. to group double or triple stacked pallets together). Any suitable Warehouse Control System may be used to these ends.

Prior to the outfeed lane 42, each assembled target pallet will receive a label and is then diverted to one of two stretch wrapper lanes. Before the wrapper, pallets may be lifted up to create double or triple stacked pallets. Finally, pallets at 29 (FIG. 2) are ready in lane 42 for pickup at 45 by fork lift operators to be transferred into the staging area or directly loaded into a truck or other discharge target.

FIG. 2 illustrates the pallet or material flow through the system 10 of FIG. 1. The arrows show the direction of pallets moved from one location to another. The volume or flow through numbers in FIG. 2 are exemplary only and do not constitute operational limitations, but do show the operational parameters of one system according to the invention.

AGV Details:

An AGV 23 is illustrated in FIG. 5. Power and navigation is provided by suitable means such as inductive wiring in the facility floor; but other systems can be used. The AGV 23 preferably includes two side wheels 48 and corner casters 49.

Each AGV 23 (of which there are many in the system as shown positionally, for example, randomly in FIG. 1) is provided with a dynamic coupling pin 50 which can be selectively raised to couple with a mobile pallet stand 22 to drive or move that stand through the system 10. A pallet stand 22 (FIG. 6) comprises a pallet-supporting surface 51 and four legs 52 on which are mounted swivel coasters 53 so the stand 22 can be driven about by an AGV 23.

AGV 23 is a cost efficient mobile platform. It is similar to an Automated Guided Vehicle, but since it operates in a contained environment it is not necessarily equipped with the usual safety equipment. It has no intelligence onboard besides the low level navigation control system.

All AGVs are controlled by a Fleet Manager controller of any suitable type which ensures an optimal AGV selection for the next transport task. The global goal on all AGV movements is minimizing traffic jams with short transportation times and travel distances.

Due to its small building height, an AGV 23 can run underneath mobile pallet stands 22, and selectively coupled thereto by selective erection of pin 50.

The dynamic pin 50 allows the AGV 23 to selectively engage with a mobile pallet stand 22, thus “pulling”, moving or transporting it to the desired target location (see FIG. 6) when the AGV is moved. The actual payload is still carried by the mobile pallet stand 22 which runs on four caster wheels 53. The pin 50 concept furthermore avoids the required racking, spinning or other motions to lift up and lower down a heavily loaded or even unloaded pallet stand as in other devices and which leads to lower cycle times and less power consumption.

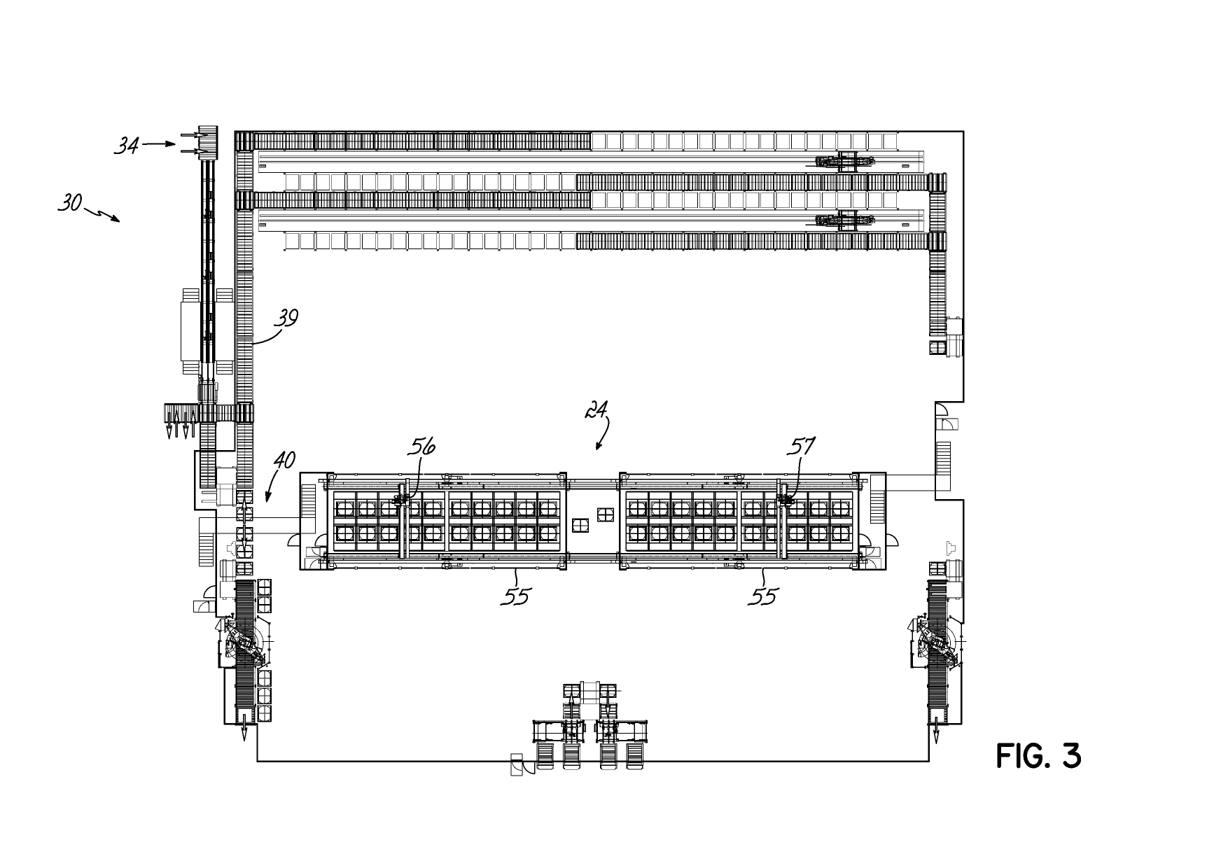

A key benefit of this AGV 23 is the minimal amount of installed or fixed equipment required for system 10. In FIG. 3, for example, only the fixed installed components are shown. Thus, the fixed components of system 10 include the infeed, lane 39 feeding the AS/RS 30, the discharge components and the HSLP 24. The other cache levels 30a, 30b and the other, closer, primary source pallet caches are defined by the mobile pallet stands 22, and/or the AGVs 23. For maintenance or cleaning purposes all mobile pallet carts 22 and AGVs 23 can be removed from the system.

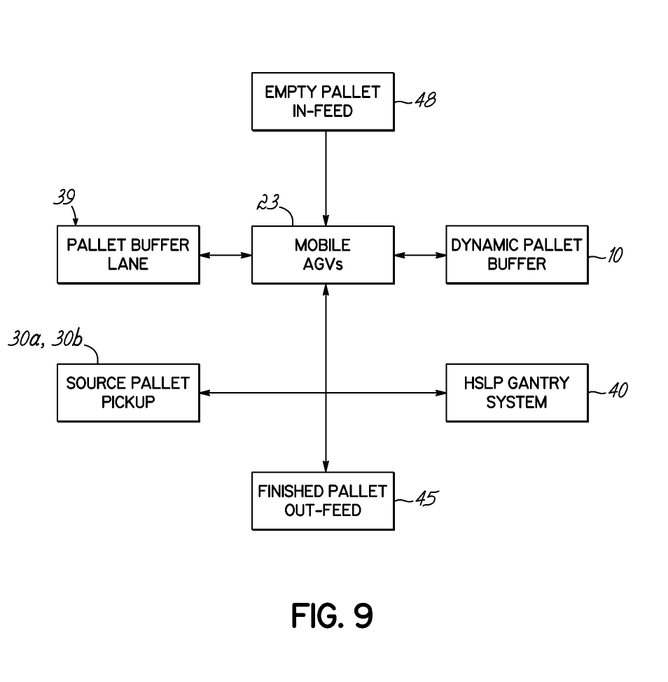

Referring to FIG. 9, it will thus be appreciated that the mobile AGVs 23 operably interface with a variety of operations of the system 10, including the empty pallet infeed 48, the pallet buffer lane 39, the dynamic pallet buffer (System 10), the same pallet pickup, the HSLP gantry system (24) and the finished pallet outfeed.

High Speed Layer Picking System 24 (HSLP):

The High Speed Layer Picking System 24 is based on an area gantry concept. This area gantry 40 design offers three degrees of freedom (X, Y and Z in FIG. 7) and is thus able to reach out to the underlying different pallet locations at HSLP 24. See FIG. 3 for example. In the preferred embodiment, two gantry “bridges” 56, 57 (FIG. 3) are added to the main gantry frame 55. Each gantry robot is controlled by a Robot Controller of any suitable type and is equipped with a layer picking gripper 100 as noted above.

As noted above, in order to provide package type flexibility, the invention can include two or more different suitable gripper types, each of suitable construction and function and including both Vacuum Layer Grippers and Roll-Up or Mechanical Layer Grippers. Such grippers are suitable for corrugated boxes; shrink wrapped items and bags. They support multiple layer picks for certain pallet configurations and are deployed in a growing number of installations throughout the world.

HSLP: The overall layout of the actual HSLP system 24 is shown in FIGS. 1, 2 and 3.

The HSLP System 24 includes one main frame 55 on which two bridges 56, 57 are running (FIG, 3). Alternately, four bridges or other number of bridges can be used. The HSLP system 24 is divided into safety zones, which are really only relevant if an operator has to enter one of the zones. On both sides, a walkway is added to allow an operator to get to the HSLP system 24 without stepping into the navigation space of the AGVs 23. Any layer slip sheets will be handled by the Layer Picking Grippers. The slip sheets are inducted through the standard entry and are delivered by the AGVs to the HSLP system 24.

Other components as now generally described can be used in connection with the system 10 and are described here for clarity and environment.

System In-Feed and Replenishment:

All inbound inventory received into the Automated Layer Picking and Buffer System 10 will be scanned and logged into a Warehouse Control System of any suitable type. The Warehouse Management System maintains control of the inventory and tracks the product all the way through the system until the final palletized product is handed back over to a discharge control at the final Stretch Wrapper. During this time, the discharge control will have full visibility of the complete inventory in the Automated Layer Picking and Buffer System 10,

Once a source pallet is scanned and before induction into the AS/RS 30, the pallet will be manually unwrapped. The barcode scanning station will be part of the manual unwrap station and the scanning process will be done manually as well by an operator.

Pallet Storage System 30:

A Pallet Storage System (AS/RS) 30 comprises, in one suitable version two AS/RS crane aisles which hold 760 pallet positions, for example.

Controls are based on any suitable PLC platform. One crane is designed to perform 110 single pallet transport missions per hour. This means it can transport 110 pallets in or out of the AS/RS or it can e.g. move 55 pallets in and 55 pallets out per hour or any combination in between.

All pallet conveyors are standard off the shelf conveyors as shown here. Each conveyor has its local VFD drive box, which simplifies the installation, commissioning and testing.

Barcode and Pre-Printed Labeling System:

Completed Palletized Order Pallets will receive a barcode label for each stack just prior to being transferred to the stretch wrapper. Labels can be pre-printed. This scheme will create some cost savings on printing in the long run for customers.

Fencing and Safety System:

The whole system 10 will be fenced in order to protect the people from walking into the Automated Layer Picking System.

At certain locations entry gates are located to allow operators and maintenance people to access the work space. At these entry gates user control boxes are located to request the entry and to put the system back into Automatic mode after everyone has left the working cell or envelope.

Pallet input/output areas will be equipped with muting light curtains which will prevent the operators to walk into the cell through a conveyor window.

The Pre-Printed Label applicator will be located just after the Layer Palletizer and just prior to the transfer to the Stretch Wrappers.

Completed orders can be palletized as a Single Pallet Order, in which the order consists of one bottom pallet only with the various products stacked in layers up to 106 inches (2692 mm) tall, for example. In addition, completed orders can be palletized as a Stacked Pallet Order, in which the order consists of 2 or more pallets, each with its own product group. These pallets can be stacked on top of each other and can be up to 106 inches (2692 mm) tall combined, for example.

The Warehouse Control System will ensure that the paired pallets are built in the appropriate sequence.

Future Expansion:

A future expansion can be easily implemented by adding more gantry robots in order to increase the throughput at HSLP 24. More buffer capacity can be added to accommodate more active SKUs in storage at 30 and more AGVs 23 can be provided to support the increased pallet traffic or define yet additional pallet caches responsive to demand criteria. As an example, FIG. 8 illustrates an expanded system having six rows of pallet storage racks served by three cranes 21, all fed pallets through lane 39 from infeed 34.

Accordingly, in one embodiment, the invention comprises a material handling system for receiving, storing and assembling products and including load storing apparatus; load assembling apparatus; a plurality of independent load carrying vehicles; a plurality of independent load supporting platforms; a coupling for selectively coupling together said vehicles and said platforms; said vehicles being moveable to transfer said platforms between load storage and load assembly apparatus.

The invention also contemplates a material handling system for reviewing, storing and assembling products on pallets and including a plurality of pallet supporting platforms; a plurality of vehicles selectively coupled to selected pallet supporting platforms of said plurality; said vehicles being automatically guided to transfer said platforms within said system.

As well, the invention also contemplates a material handling system for handling pallets and products thereon and comprising: a source pallet infeed; a first source pallet storage and receiving apparatus for receiving infed pallets and storing thereon; a load building apparatus for transferring homogeneous or similar product layers from a source pallet to a target pallet responsive to a product order; a plurality of automatic guided vehicles; a plurality of moveable pallet stands; a coupler for selectively coupling a vehicle to a pallet stand; said vehicles and said stands being moveable along predetermined paths to transfer pallets fro said storage and receiving apparatus and said building apparatus.

The invention further contemplates a method of building a pallet with a product mix thereon and including the steps of receiving and storing source pallets in a first location; transferring source pallets on a moveable platform to a target pallet building apparatus; moving the platform with an automatically guided vehicle; building a pallet on a platform with homogeneous or similar product layers in both single and multiple layer picks to order.

Accordingly, it will be appreciated the invention contemplates an automated layer picking and storage system which is modular, scalable, expandable and which provides dynamic storage and load building apparatus and methods

These and other advantages and modifications of the invention will be readily appreciated to those of ordinary skill in the art from the foregoing description and drawings, without departing from the scope of the invention, and applicant intends to be bound only by the claims appended hereto,

What is claimed is:

1. A material handling system for receiving, storing and assembling products and including:
load storing apparatus;
load assembling apparatus;
a plurality of independent load transporting vehicles;
a plurality of independent load supporting platforms;
a coupling for selectively coupling together said vehicles and said platforms for movement of the platforms by the vehicles;
said vehicles being moveable to transfer said platforms between load storage and load assembly apparatus.

2. A system as in claim 1 wherein said load storage apparatus comprises a fixed storage apparatus and at least one programmable storage cache defined by positions of said platforms proximate said assembling apparatus, and closer thereto than said fixed storage apparatus.

3. A material handling system for reviewing, storing and assembling products on pallets and including:
a plurality of pallet supporting platforms;
a plurality of vehicles selectively coupled to selected pallet supporting platforms of said plurality;
said vehicles being automatically guided to transfer said platforms within said system.

4. A system as in claim 3 including a product assembly apparatus disposed over a plurality of said platforms for assembling homogeneous or similar product layers onto target pallets from source pallets.

5. A material handling system for handling pallets and products thereon and comprising:
a source pallet infeed;
a first source pallet storage and receiving apparatus for receiving infed pallets and storing thereon;
a load building apparatus for transferring homogeneous or similar product layers from a source pallet to a target pallet responsive to a product order;
a plurality of automatic guided vehicles;
a plurality of moveable pallet stands;
a coupler for selectively coupling a vehicle to a pallet stand;
said vehicles and said stands being moveable along predetermined paths to transfer pallets fro said storage and receiving apparatus and said building apparatus.

6. A system as in claim 5 wherein said pallet stands are grouped to define another storage and retrieval apparatus for pallets received from said infeed, said other storage and retrieval apparatus disposed closer to said building apparatus than said first storage and assembly apparatus.

7. A system as in claim 5 wherein said building apparatus comprises product gripping apparatus for gripping and moving homogeneous or similar product layers in both single and multiple player picks from pallets on one stand to pallets on another stand.

8. A system as in claim 7 wherein at least one of said stands is operatively coupled to a vehicle under said building apparatus.

9. A system as in claim 5 wherein said first source pallet storage and retrieval system is fixed in location and further including another source pallet storage and retrieval system defined by pallet stands in programmable locations as a function of product demand frequency.

10. A method of building a pallet with a product mix thereon and including the steps of:
receiving and storing source pallets in a first location;
transferring source pallets on a moveable platform to a target pallet building apparatus;
moving the platform with an automatically guided vehicle;
building a pallet on a platform with homogeneous or similar product layers in both single and multiple layer picks to order.

11. A method as in claim 10 including the step of further storing source pallets on said platforms in second locations other than said first locations.

12. A method as in claim 11 including the step of minimizing the distance between said second location and a location where products are built to order.

13. A method as in claim 12 including defining the position of said second location as a function of the most frequently built products.
